(19) United States
(12) Patent Application Publication
(10) Pub. No.: US 2009/0000717 A1
(43) Pub. Date: Jan. 1, 2009

(54) Steel Cord, Rubber-Steel Cord Composite and Tire

(75) Inventor: Kiyoshi Ikehara, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, CHUO-KU, TOKYO (JP)

(21) Appl. No.: 12/279,219

(22) PCT Filed: Feb. 7, 2007
(86) PCT No.: PCT/JP2007/052150

§ 371 Date: Aug. 13, 2008

(30) Foreign Application Priority Data
Feb. 15, 2006 (JP) 2006-037822

(51) Int. Cl. B60C 9/00

(52) U.S. Cl. 152/451

(57) ABSTRACT

A steel cord that is especially useful for reinforcing a crown portion of a tire is provided. In particular, a steel cord free from manufacturing problems existed in the conventional art and allowing for stable quality and good production efficiency is provided, and a rubber-steel cord composite and a tire that are equipped with the same are provided.

A steel cord has a multiple-twist structure including N (N=2 to 8) strands 2 that are twisted together, each strand 2 having a plurality of wires 1 that are twisted together. When the diameter of each strand is denoted by d (mm), the diameter of a circle circumscribing the cord is denoted by D (mm), and the twisting pitch of the cord is denoted by P (mm), ε_{c} defined by the following expression, ε_{c}=√(−b/2+√(b²/4−c))−1 (where b denotes −1+π²(−4R²+d²)/P², c denotes π²d²k(4π²R²+P²)/P⁴, R denotes (D−d)/2, and k denotes tan²(π/2−π/N)), satisfies ε_{c}≧0.005.

### TECHNICAL FIELD

The present invention relates to steel cords, rubber-steel cord composites (which will simply be referred to as “cords” and “composites”, respectively, hereinafter) and tires. More specifically, the present invention relates to steel cords suitably used for reinforcing various rubber products, such as tires, belts, and hoses, and to rubber-steel cord composites and tires equipped with the same.

### BACKGROUND ART

Steel cords are variously used for reinforcing composites by being embedded in matrices of, for example, rubber. In particular, although rubber itself in a rubber product lacks strength and rigidity, a rubber-steel cord composite in which the rubber is reinforced by a steel cord can have sufficient strength and rigidity. For this reason, rubber-steel cord composites are widely used in various rubber products, such as tires, belts, and hoses.

Normally, a product containing such a composite is manufactured through a molding process performed while the matrix is in a fluid or flexible state. However, in this process, because the steel cord to be used for reinforcement is rigid, the flexibility at the time of the molding process is often limited. For this reason, in a conventional steel cord, increasing the strength and rigidity of the product and achieving flexibility during the manufacturing process conflict with each other.

Since tires are circular and are thus mostly occupied by curved surfaces, flexibility is especially required in the manufacturing process therefor. Specifically, in a vulcanization process, a tire is normally expanded inside an oven so that the tire can be fit into a mold. On the other hand, after the tire is made into a product, it is important that the tire have high strength and rigidity as well as dimensional stability so that it can withstand heavy-duty use over a long period of time and exhibit stable performance. In particular, a crown portion of a tire when in use constantly receives tensile force in the circumferential direction thereof due to the internal pressure. As the tire is used, the tensile force can cause the crown portion to creep and to become longer in the circumferential direction, thus reducing the durability as a result of strain as well as changing the cross-sectional shape of the tire to deteriorate the abrasion characteristics.

In contrast, Patent Document 1, for example, discloses a technology for reinforcing the crown portion of a tire. Specifically, a tread portion around a carcass includes two layers of crossover belts and at least one crown reinforcement layer positioned therebelow, the crown reinforcement layer being formed of strips of reinforcement elements that are wholly oriented along the equator, the reinforcement elements being multiple cords (or filaments) forming a corrugated or zigzag pattern. Accordingly, this technology can effectively prevent the occurrence of separations without increasing the weight of the tire.

Furthermore, it is also disclosed in Patent Document 1 that the use of strips of corrugated or zigzag patterned cords or filaments wholly oriented along the equator as a crown reinforcement layer facilitates the manufacturing process since expansion at the time of vulcanization can be readily attained.

Patent Document 1: Japanese Unexamined Patent Application Publication No. H2-208101 (Claims, etc.)

### DISCLOSURE OF INVENTION

### Problems to be Solved by the Invention

However, with the technology disclosed in Patent Document 1, in order for the steel cord to exhibit sufficient rigidity after the tire becomes a product, the corrugated or zigzag pattern needs to be stretched and substantially straightened in a state where internal pressure is applied to the product. Therefore, in order to allow the physical properties of the tire as a product to be in accord with a target value, high accuracy is required in the molding process, which is problematic in terms of production efficiency.

An object of the present invention is to provide a steel cord that is especially useful for reinforcing a crown portion of a tire, that is free from manufacturing problems existed in the conventional art, and that allows for stable quality and good production efficiency, and to provide a rubber-steel cord composite and a tire that are equipped with the same.

### Means for Solving the Problems

In order to solve the aforementioned problems, a steel cord according to the present invention has a multiple-twist structure including N (N=2 to 8) strands that are twisted together, each strand having a plurality of wires that are twisted together. When a diameter of each strand is denoted by d (mm), a diameter of a circle circumscribing the cord is denoted by D (mm), and a twisting pitch of the cord is denoted by P (mm), ε_{c} defined by the following expression

ε_{c}=√(−b/2+√(b²/4−c))−1

(where b denotes −1+π²(−4R²+d²)/P², c denotes π²d²k(4πR²+P²)/P⁴, R denotes (D−d)/2, and k denotes tan²(π/2-π/N)) satisfies ε_{c}≧0.005. Preferably, in the steel cord according to the present invention, ε_{c}≧0.015 is satisfied.

Furthermore, a rubber-steel cord composite according to the present invention is formed by embedding the steel cord according to the present invention in rubber. In the composite according to the present invention, the N strands preferably have a gap in at least one section therebetween.

A tire according to the present invention includes a reinforcement layer that includes the rubber-steel cord composite according to the present invention as a reinforcement member. Preferably, the reinforcement layer is formed by wrapping the reinforcement member around a crown portion of the tire by at least one turn.

More specifically, a tire according to the present invention includes at least a pair of carcasses serving as a framework and extending in a toroidal form between at least a pair of bead cores, and at least one layer of belt extending around an outer periphery of the carcasses and having a plurality of cords or filaments serving as reinforcement elements that form a slanted angle of 10° to 40° with respect to an equatorial plane of the tire.

The tire is provided with at least one crown reinforcement layer formed on an inner periphery side of the belt which is the outer periphery of the carcasses, the at least one crown reinforcement layer being formed of strips of the rubber-steel cord composite according to the present invention that are wholly oriented in a circumferential direction of the tire.

Another tire according to the present invention includes at least a pair of carcasses serving as a framework and extending in a toroidal form between at least a pair of bead cores, and at least two layers of crossover belts extending around an outer periphery of the carcasses and having a plurality of cords or filaments serving as reinforcement elements that form a slanted angle of 10° to 40° with respect to an equatorial plane of the tire and that cross over each other between the at least two layers with the equatorial plane therebetween.

The tire is provided with at least one crown reinforcement layer formed on an inner periphery side of the crossover belts which is the outer periphery of the carcasses, the at least one crown reinforcement layer being formed of strips of the rubber-steel cord composite according to the present invention that are wholly oriented in a circumferential direction of the tire.

### EFFECT OF THE INVENTION

According to the present invention, with the above-described configuration, a steel cord that is especially useful for reinforcing a crown portion of a tire and that allows for stable quality and good production efficiency can be provided, and moreover, a rubber-steel cord composite and a tire that are equipped with the same can also be provided.

### BRIEF DESCRIPTION OF DRAWINGS

FIG. 1 is a cross-sectional view showing an example of a steel cord according to the present invention.

FIG. 2 is an enlarged cross-sectional view of a tread portion in an example of a tire according to the present invention.

FIG. 3 includes part (a) showing an enlarged cross-sectional view of a tread portion of a tire in comparative examples, and part (b) showing a schematic plan view of a rubber-steel cord composite according to the comparative examples.

FIG. 4 is a graph that shows the relationship between strain and stress with regard to rubber-steel cord composites of a comparative example and an embodiment.

### REFERENCE NUMERALS

1 wire
2 strand
10 tire
11 carcass
12 crossover belt
13 crown reinforcement layer

### BEST MODES FOR CARRYING OUT THE INVENTION

Preferred embodiments of the present invention will be described below.

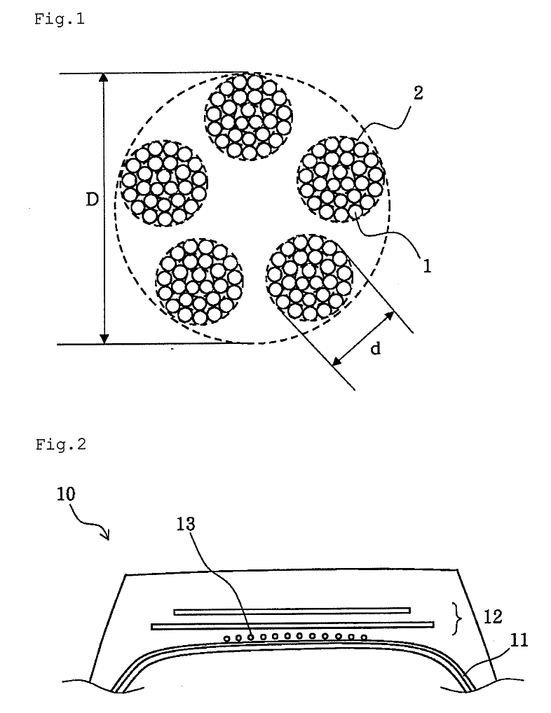

FIG. 1 is a cross-sectional view showing an example of a steel cord according to the present invention. As shown in the figure, the steel cord according to the present invention has a multiple-twist structure including N (N=2 to 8) strands 2 that are twisted together, i.e. 5 strands 2 twisted together in the example shown in the figure, each strand 2 having a plurality of wires 1 that are twisted together, preferably, 5 to 49 wires 1 twisted together. When the diameter of each strand is denoted by d (mm), the diameter of a circle circumscribing the cord is denoted by D (mm), and the twisting pitch of the cord is denoted by P (mm), s, defined by the following expression

ε_{c}=√(−b/2+√(b²/4−c))−1

(where b denotes −1+π²(−4R²+d²)/P², c denotes π²d²k(4πR²+P²)/P⁴, R denotes (D−d)/2, and k denotes tan²(π/2-π/N)) satisfies ε_{c}≧0.005.

With ε_{c} defined by the above expression satisfying ε_{c}≧0.005, or preferably ε_{c}≧0.015, the N strands 2 in the steel cord can have a certain gap or larger formed in at least one section therebetween or all of the strands 2 in the example shown in the figure can have certain gaps or larger formed therebetween; hence, even when this cord is embedded within a matrix of, for example, rubber, the gap or gaps would be present between the strands 2. Therefore, when the matrix is in a flexible state, the cord can readily be stretched to withstand a certain degree of strain with respect to tensile strain applied to the cord. Accordingly, the molding process for the product becomes easier, and the time for expansion at the time of vulcanization during a tire manufacturing process can be extended, thereby achieving an advantage of an easier manufacturing process.

On the other hand, when the fluidity of the matrix decreases as in vulcanized rubber, as described above, even if the strands 2 have the gap or gaps therebetween, the steel cord favorably becomes incapable of being deformed like a coil spring with reducible gap or gaps. Thus, the rigidity of steel becomes exhibited as if there were no gaps. Consequently, when the steel cord according to the present invention becomes a product, the tensile rigidity thereof becomes less susceptible to the magnitude of strain applied to the steel cord during processing, and the steel cord constantly becomes highly rigid. Although it is preferable in terms of fatigability that there be a gap or gaps remaining between the strands when the cord is in the product state, the cord according to the present invention as described above will not decrease significantly in tensile rigidity even in such a state as compared to the case where the strands 2 are closely in contact with each other.

Accordingly, the present invention can provide a steel cord that allows for good production efficiency and that can exhibit sufficient rigidity to serve as a reinforcement member after a tire becomes a product, and a rubber-steel cord composite formed by embedding this steel cord in rubber.

A tire according to the present invention may be of a type that is equipped with a reinforcement layer that employs the rubber-steel cord composite according to the present invention as a reinforcement member. Consequently, the reinforcement layer can exhibit desired high rigidity, whereby a tire with excellent durability and abrasion resistance properties can be achieved. The present invention is especially effective when applied to truck and bus radial (TBR) tires, which are used under high internal pressure and whose crown portion receives high tension in the circumferential direction. The reinforcement layer equipped in the tire according to the present invention is preferably formed by wrapping the reinforcement member made of the aforementioned rubber-steel cord composite around the crown portion of the tire by at least one turn.

FIG. 2 is an enlarged cross-sectional view of a tread portion in an example of a tire according to the present invention employing the rubber-steel cord composite according to the present invention as reinforcement members. A tire 10 shown in the figure has at least a pair of carcasses 11 serving as a framework and extending in a toroidal form between at least a pair of bead cores (not shown), at least two layers of crossover belts 12 extending around the outer periphery of the carcasses 11 and having a plurality of cords or filaments serving as reinforcement elements that form a slanted angle of 10° to 40° with respect to a plane including the central circumference of the tire, that is, the equatorial plane of the tire and that cross over each other between the at least two layers with the equatorial plane therebetween, and at least one crown reinforcement layer 13 disposed on the inner periphery side of the crossover belts 12, that is, the outer periphery of the carcasses 11 and formed of strips of the aforementioned rubber-steel cord composite that are wholly oriented in the circumferential direction of the tire.

Although the advantages of the present invention are not limited to the example shown in the figures and are achievable with respect to any kind of tire, the present invention is especially effective in a TBR tire as mentioned above. In particular, by applying the composite according to the present invention to the crown reinforcement layer 13 as shown in FIG. 2, the expansion at the time of vulcanization can be readily attained, thereby facilitating the manufacturing process. In addition, fluctuation in the physical properties of the product can be reduced with respect to fluctuation in expansion at the time of vulcanization, whereby stable quality can be advantageously assured.

Alternatively, although not shown in the figures, the crossover belts 12 in the tire may be replaced with at least one layer of a belt that has a plurality of cords or filaments serving as reinforcement elements that form a slanted angle of 10° to 40° with respect to the equatorial plane of the tire. In such a tire, the inner periphery side of the belt, that is, the outer periphery of the carcasses may be provided with the crown reinforcement layer 13 in which the composite according to the present invention is used as reinforcement members. In this manner, it is needless to say that the same advantages as described above can be achieved.

The tire according to the present invention may be of a type in which the aforementioned rubber-steel cord composite according the present invention is employed in a reinforcement layer, specifically, as reinforcement members in the crown reinforcement layer, and with this structure, the desired advantages of the present invention can be achieved. The specific structures and materials of the tire as well as the specific cord diameter, twisting pitch, and the number of reinforcement members to be embedded in the reinforcement layer are not particularly limited and may be appropriately set as in the usual manner.

### EMBODIMENTS

Embodiments of the present invention will be described below in further detail.

### Comparative Example 1

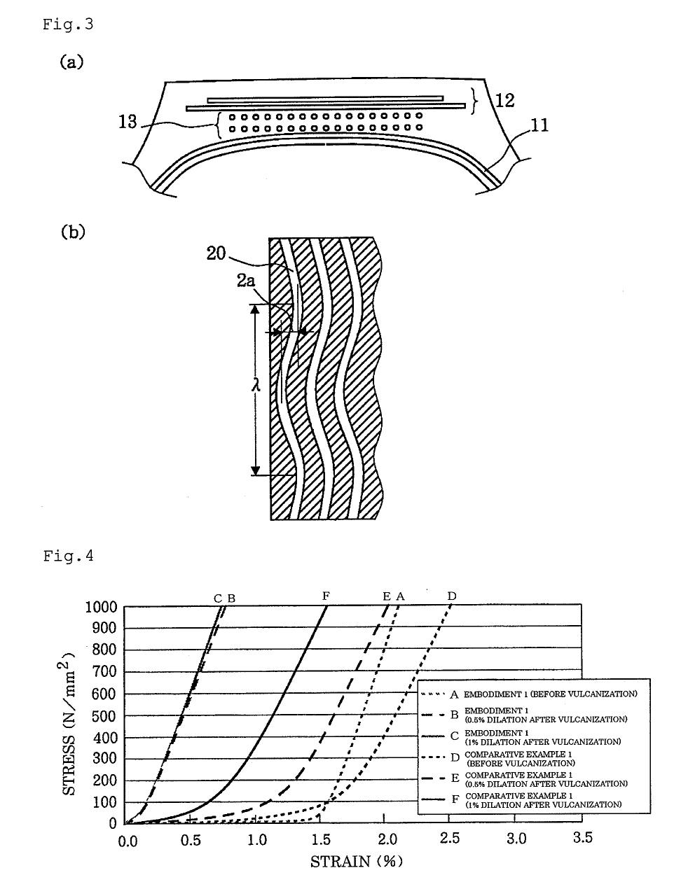

Cords 20 having a cord structure 3+9+15×0.23 conventionally used as reinforcement members in a TBR tire are arranged parallel to each other and embossed with a corrugated pattern (wavelength: X, amplitude: 2a) as shown in plan view of FIG. 3(b). These cords 20 are then embedded in rubber, thereby forming a rubber-steel cord composite of Comparative Example 1.

### Embodiments 1 and 2 and Comparative Example 2

Using cords having the same structure as in Comparative Example 1 as strands, five of these are twisted together and embedded in rubber, thereby forming rubber-steel cord composites of Embodiments 1 and 2 and Comparative Example 2. With regard to each composite obtained, the values for the strand diameter d, the diameter D of a circle circumscribing the cord, the twisting pitch P of the cord, and ε_{c} are shown in Table 1 below.

FIG. 4 is a graph that shows evaluation results for the relationship between strain and stress with regard to the composites obtained in Comparative Example 1 and Embodiment 1. In the figure, the values for 0.5% expansion after vulcanization and 1% expansion after vulcanization correspond to values measured after each composite was vulcanized in a 0.5% or 1% expanded state. As a result, it is apparent from the figure that the composite in Embodiment 1 has low rigidity and good moldability before vulcanization, and, after vulcanization, has higher rigidity than the composite in Comparative Example 1 corresponding to a conventional product. Regarding the physical properties after vulcanization, the composite in Embodiment 1 appears to be less affected by expansion at the time of vulcanization.

Next, the composite formed in Comparative Example 1 was employed as reinforcement members in a radial reinforcement layer in the tire structure shown in FIG. 3(a), and the composite formed in each of Embodiments 1 and 2 and Comparative Example 2 was employed as reinforcement members in a radial reinforcement layer in the tire structure shown in FIG. 2. Four tires with a tire size of 265/60R22.5 were formed and set to rims with a rim width of 8.25 so as to be mounted on a commercial truck. Each tire was then filled with an internal pressure of 900 kPa. Subsequently, with an average load of 25480 N (2600 kgf) applied, the truck was driven for 100,000 km, 30% of which being on paved highway and 70% of which being on general paved road. Upon completion of the driving, the depth of the center groove and the depths of the shoulder grooves were measured, and the difference in abrasion loss therebetween (biased abrasion difference) was compared with respect to the brand-new state. As a result, there was a difference of 2 mm or more in the tire in Comparative Example 1, whereas there was a difference of 1 mm or less in each of the tires in Embodiments 1 and 2 and Comparative Example 2. Abrasion loss is not a problem and is satisfactory if it is 1 mm or less. These results and the evaluation results concerning the moldability are shown in Table 1 below. The evaluation results for the moldability are shown based on the following standards: ⊚ indicating that there is no problem, ◯ indicating that there is no problem if made highly accurate, and X indicating that the tire is not fittable in a mold and that the crown shape is defective.

TABLE 1

| | Comparative | | Comparative | |
|---|---|---|---|---|
| | Example 1 | Embodiment 1 | Example 2 | Embodiment 2 |
| Cord Structure | 3 + 9 + 15 × 0.23 | 5 × (3 + 9 + 15 × | 5 × (3 + 9 + 15 × | 5 × (3 + 9 + 15 × |
| | | 0.23) | 0.23) | 0.23) |
| Corrugation 2a/λ | 0.078 | — | — | — |
| Strand Diameter d | — | 1.42 | 1.42 | 1.42 |
| (mm) | | | | |
| Cord Diameter D (mm) | — | 4.39 | 3.91 | 4.06 |
| Cord Pitch P (mm) | — | 30 | 30 | 30 |
| ε_{c} | — | 1.5 | 0.001 | 0.005 |
| Embedded Number | 45/100 mm | 18/100 mm | 18/100 mm | 18/100 mm |
| Number of Crown | 2 layers | 1 layer | 1 layer | 1 layer |
| Reinforcement Layers | | | | |
| Biased Abrasion | 2 mm or more | 1 mm or less | 1 mm or less | 1 mm or less |
| Difference | | | | |
| Moldability | ⊚ | ⊚ | X | ◯ |

As shown in Table 1 above, the tire according to each of Embodiments 1 and 2 that employs the multiple-twisted cords as reinforcement members, in which sc defined by the aforementioned expression satisfies ε_{c}≧0.005, was confirmed to have excellent biased abrasion properties as well as excellent moldability.

1. A steel cord having a multiple-twist structure including N (N=2 to 8) strands that are twisted together, each strand having a plurality of wires that are twisted together, wherein when a diameter of each strand is denoted by d (mm), a diameter of a circle circumscribing the cord is denoted by D (mm), and a twisting pitch of the cord is denoted by P (mm), by P (mm), ε_{c} defined by the following expression, ε_{c}=√(−b/2+√(b²/4−c))−1 (where b denotes −1+π²(−4R²+d²)/P², c denotes π²d²k(4π²R²+P²)/P⁴, R denotes (D−d)/2, and k denotes tan²(π/2−π/N)), satisfies ε_{c}≧0.005.

2. The steel cord according to claim 1, wherein ε_{c}≧0.015 is satisfied.

3. A rubber-steel cord composite formed by embedding the steel cord according to claim 1 in rubber.

4. The rubber-steel cord composite according to claim 3, wherein the N strands have a gap in at least one section therebetween.

5. A tire comprising a reinforcement layer that includes the rubber-steel cord composite according to claim 3 as a reinforcement member.

6. 1. The tire according to claim 5, wherein the reinforcement layer is formed by wrapping the reinforcement member around a crown portion of the tire by at least one turn.

7. A tire comprising at least a pair of carcasses serving as a framework and extending in a toroidal form between at least a pair of bead cores, and at least one layer of belt extending around an outer periphery of the carcasses and having a plurality of cords or filaments serving as reinforcement elements that form a slanted angle of 10° to 40° with respect to an equatorial plane of the tire,
wherein the tire is provided with at least one crown reinforcement layer formed on an inner periphery side of the belt which is the outer periphery of the carcasses, the at least one crown reinforcement layer being formed of strips of the rubber-steel cord composite according to claim 3 or 4 that are wholly oriented in a circumferential direction of the tire.

8. A tire comprising at least a pair of carcasses serving as a framework and extending in a toroidal form between at least a pair of bead cores, and at least two layers of crossover belts extending around an outer periphery of the carcasses and having a plurality of cords or filaments serving as reinforcement elements that form a slanted angle of 10° to 40° with respect to an equatorial plane of the tire and that cross over each other between the at least two layers with the equatorial plane therebetween,
wherein the tire is provided with at least one crown reinforcement layer formed on an inner periphery side of the crossover belts which is the outer periphery of the carcasses, the at least one crown reinforcement layer being formed of strips of the rubber-steel cord composite according to claim 3 that are wholly oriented in a circumferential direction of the tire.

9. A rubber-steel cord composite formed by embedding the steel cord according to claim 2 in rubber.

10. A tire comprising a reinforcement layer that includes the rubber-steel cord composite according to claim 4 as a reinforcement member.

11. A tire comprising at least a pair of carcasses serving as a framework and extending in a toroidal form between at least a pair of bead cores, and at least two layers of crossover belts extending around an outer periphery of the carcasses and having a plurality of cords or filaments serving as reinforcement elements that form a slanted angle of 10° to 40° with respect to an equatorial plane of the tire and that cross over each other between the at least two layers with the equatorial plane therebetween,
wherein the tire is provided with at least one crown reinforcement layer formed on an inner periphery side of the crossover belts which is the outer periphery of the carcasses, the at least one crown reinforcement layer being formed of strips of the rubber-steel cord composite according to claim 4 that are wholly oriented in a circumferential direction of the tire.
